(19) United States
(12) Patent Application Publication
(10) Pub. No.: US 2011/0194733 A1
(43) Pub. Date: Aug. 11, 2011

(54) SYSTEM AND METHOD FOR OPTICAL LICENSE PLATE MATCHING

(75) Inventor: James Wilson, Dyer, IN (US)

(73) Assignee: TC License Ltd., Hummelstown, PA (US)

(21) Appl. No.: 13/025,744

(22) Filed: Feb. 11, 2011

Related U.S. Application Data
(60) Provisional application No. 61/303,634, filed on Feb. 11, 2010.

(51) Int. Cl. G06K 9/00

(52) U.S. Cl. 382/105

(57) ABSTRACT

An automated system and method are disclosed for reading license plate characters and associating the image with a vehicle by comparing to existing images and supplementing the automated system with manual review, comprising: capturing a first license plate image; processing the first image with optical character recognition equipment to produce an OCR result; associating the OCR result with a confidence level. If the confidence level is above a predetermined threshold, determining whether the OCR result matches a previously-obtained OCR result and if the confidence level is not above the predetermined threshold, presenting the first image for a manual review to produce a manual result.

### CROSS-REFERENCE TO RELATED APPLICATIONS

This utility application claims the benefit under 35 U.S.C. §119(e) of Provisional Application Ser. No. 61/303,634, filed on Feb. 11, 2010 and entitled System and Method for Optical License Plate Matching. The entire disclosure of this application is incorporated by reference herein.

### FIELD OF THE INVENTION

The invention relates generally to the field of image recognition and more particularly to the field of vehicle license plate identification.

### BACKGROUND OF THE INVENTION

Electronic Toll Collection (ETC) systems operate typically as a combination of multiple technologies. A basic ETC system includes a vehicle classification system, an RFID system to identify vehicles based on tags mounted on or in those vehicles, a vehicle separator that is used to determine the start and stop points for vehicles as they pass through the lanes, and a video enforcement/tolling system.

Two categories of vehicles will appear on the toll road, tagged and untagged vehicles. When a tagged vehicle approaches the toll point, the vehicle's tag is read by the RFID system and the classification is determined by the classification system. A transaction including at least the tag ID and usually also the vehicle class is formed and sent to a back office where an account associated with the tag ID is charged the toll amount corresponding to the toll agency's business rules.

If a tag is not present (untagged vehicle), a camera is triggered to take one or more photos of the rear license plate of the vehicle. The image is then processed manually or automatically or both to extract the license plate number. The toll authority then typically obtains the vehicle owner information and can issue a toll violation citation to the vehicle owner. Many toll agencies also associate the one or more vehicle license plate numbers to an account in addition to the tag ID, and therefore if a plate is read, the plate number is first looked up in the authority's database to determine if the plate is associated with an account and the account is charged the associated toll (and sometimes a surcharge) to the account associated with the plate number. This process is typically called a Video Toll or VTOLL transaction. Some agencies will also look up state department of motor vehicle data on plates for which they do not have accounts, and then issue bills to the registered vehicle owner (sometimes plus a service fee or surcharge) provided they have the legal authority to do so.

In some cases toll agencies will trigger and retain and or process images of license plates from all vehicles, but will segregate the transactions into tag and VTOLL transactions. In either case, the VTOLL transaction acts as a supplementary method of toll collection rather than simply an automated method of enforcing the use of RFID tags by motorists using the toll facility. VTOLLs have the advantage that they capture toll payments from vehicles that do not have RFID tags. This helps in cases where tags are not read because they are mis-mounted, have dead batteries, or are lost or forgotten. It is also useful to capture toll payments from “casual users” users who have decided for whatever reason not to sign up for an account and obtain a toll tag. VTOLLS can also be a very important component of ETC system collections in an open road tolling (ORT) environment where no cash collection option exists. Casual users can still use the roadway, and revenue from these users can be collected using VTOLLS. VTOLLS therefore become an enabler for ORT implementations that eliminate the need for cash collections, which has several well known advantages to toll operators, including lower operating costs and enhanced traffic flow.

However VTOLLS also suffer from issues that limit their applicability beyond a supplemental collection role in ETC system. One significant issue is the propensity for Optical Character Recognition (OCR) systems, used to automatically read the license plate number, to make mistakes in reading the plate number. This misread rate is crucial since every misread of a license plate number used to generate a VTOLL transaction has the potential to cause the incorrect person to be billed for a toll. This is a very serious situation as such errors erode the credibility of the toll billing system. As a result, only an extremely low false read rate can be tolerated in VTOLL systems. To cope with this, most VTOLL systems today require a significant amount of manual (human) review of license plate images to filter out such potential errors. This adds significant cost to the VTOLL process thus making it less attractive as a toll collection method, and generally limiting its role to a supplementary method of collection.

Thus a need exists for a robust system for enhancing the accuracy of license-plate based video tolling systems.

### SUMMARY OF THE INVENTION

In an embodiment of the invention there is disclosed herein a method for reading license plate characters comprising: capturing a first license plate image; processing the first image with optical character recognition equipment to produce an OCR result; associating the OCR result with a confidence level. If the confidence level is above a predetermined threshold, determining whether the OCR result matches a previously-obtained OCR result and if the confidence level is not above the predetermined threshold, presenting the first image for a manual review to produce a manual result.

In a further embodiment, in the case where the confidence level is not above the predetermined threshold, providing at least one additional image for manual review of the first image.

In a further embodiment, is performed the step of determining whether the first image contains multiple license plates. In a further embodiment, is performed the step of determining whether the first image shows a vehicle straddling more than one traffic lane.

In a further embodiment, in the case where the OCR result confidence level is above the predetermined threshold, determining whether the OCR result for a previously analyzed image that matches the OCR result of the current image was verified by manual image review. In the case where the confidence level is above the predetermined threshold and where the OCR result for a previously-analyzed image was verified by manual image review, determining whether the confidence level is above a second predetermined level, and if so, associating the OCR result with a video toll transaction. In the case where the OCR confidence level is above the first predetermined threshold but where the OCR result for a previously-analyzed image was not verified by manual image review, associating the first image with a first identifying flag and presenting the first image for manual review. In the case where the confidence level is above the predetermined threshold and where the OCR result for a previously analyzed image was verified by manual image review, determining whether the confidence level is above a second predetermined level, and if not, associating the first image with a second identifying flag and presenting the first image for manual review.

### DESCRIPTION OF THE DRAWINGS

FIGS. 1A, 1B and 1C are a flow diagram of an exemplary method of processing license plate images.

FIG. 2 is an exemplary system for obtaining, processing and associating license plate images with a toll transaction

### DESCRIPTION OF THE PREFERRED EMBODIMENT OF THE INVENTION

Those skilled in the art will recognize other detailed designs and methods that can be developed employing the teachings of the present invention. The examples provided here are illustrative and do not limit the scope of the invention, which is defined by the attached claims.

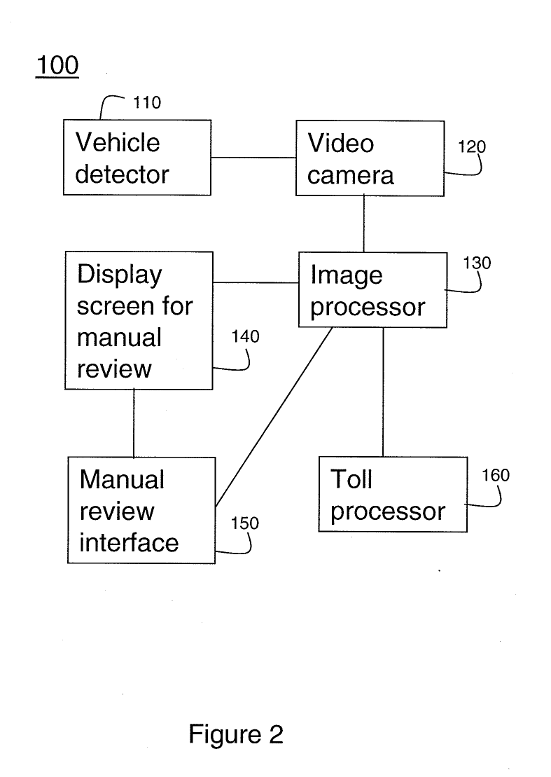

FIG. 2 shows an exemplary system 100 for obtaining, processing and associating license plate images with a toll transaction. A vehicle detector 110 detects a vehicle in range of a video camera 120 and signals the video camera to record an image of the vehicle. Those skilled in the art will know there are various existing systems for vehicle detection and for signaling the video camera 120 to capture an image at the appropriate time for there to be a high likelihood of the image including the license plate of the vehicle. The camera image is sent to an image processor 130, where an Optical Character Recognition (OCR) algorithm is performed to extract license plate number and letter data from the image and any other relevant information such as marks or images associated with a particular license-issuing entity. The image processor is connected to equipment for manual review of the image, including a display 140 and an interface 150 for the reviewer to enter data into the image processor. The image processor 130 is also connected to a toll processor 160, which receives the processed information from the image processor, which can be a license plate number and issuing authority identity.

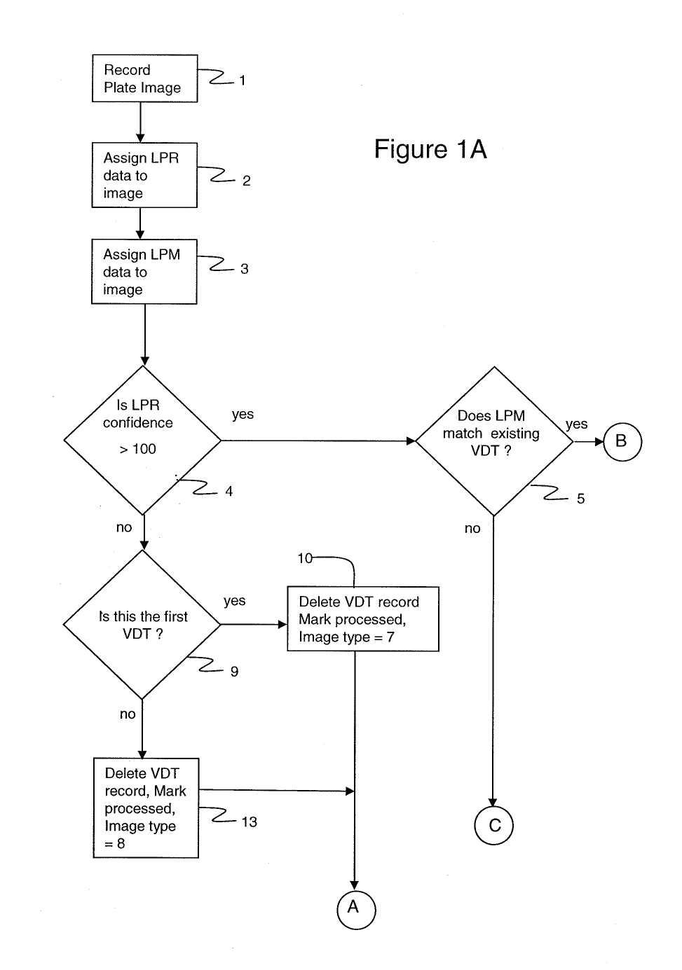

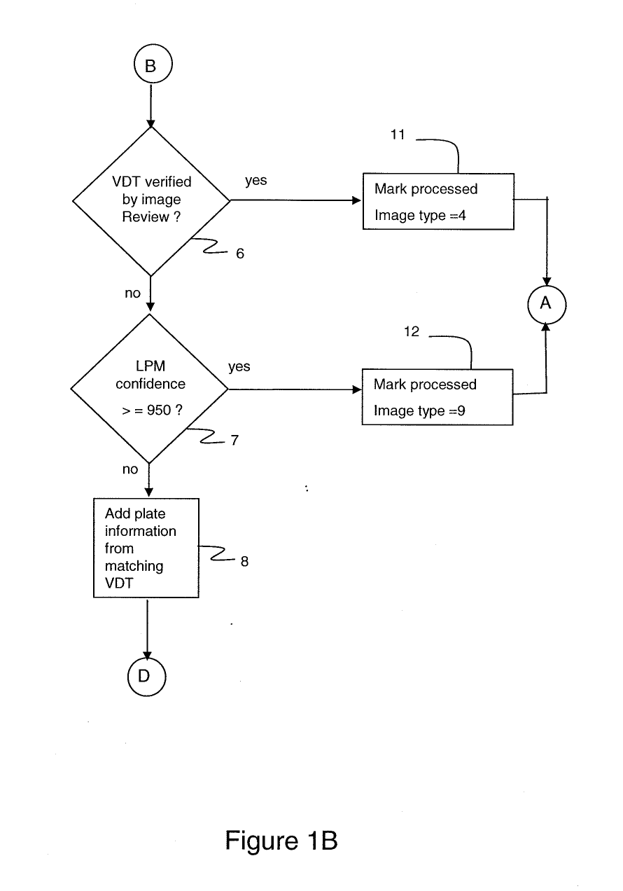

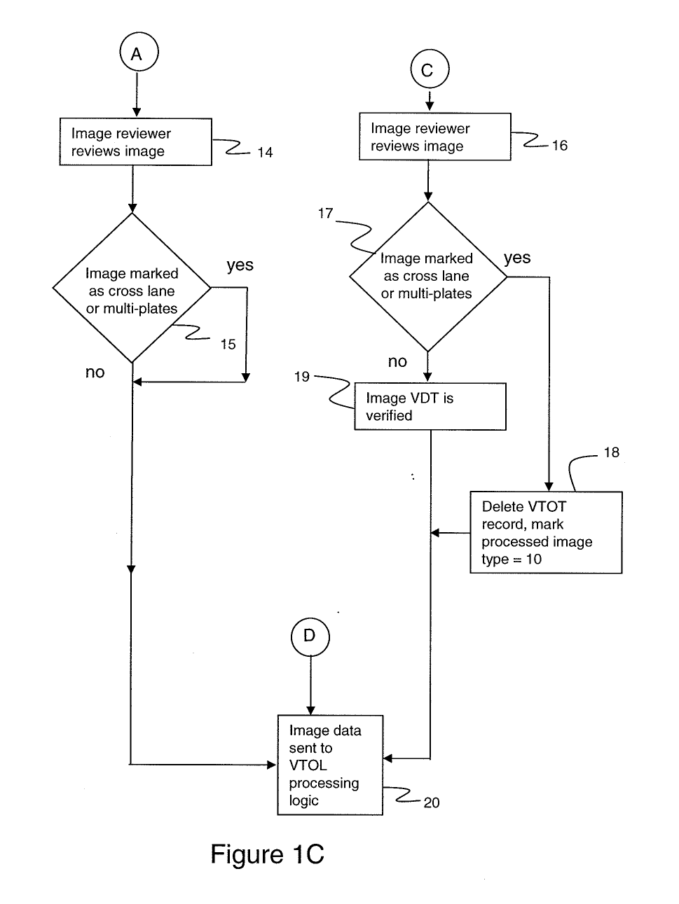

With reference to FIGS. 1A-C, an exemplary process for processing vehicle data tag (VDT) (which, in an embodiment, could be license plate) images is disclosed thus. At step 1, an image is recorded. At step 2 an optical character reader (OCR) result for license plate type and number (LPR), including an LPR confidence level as to the OCR result is assigned to the image. Factors that lead to the OCR confidence level are well known in the art of optical character recognition and image recognition. At step 3, a license plate match (LPM) data is assigned to the image in the form of a digital signature, including an LPM confidence level. At decision point 4, it is determined whether the LPR confidence level is greater than 100 (out of 1000), i.e. 10%. If the confidence level is greater than 100, then the process proceeds to decision point 5. If the confidence level is 100 or less, then the process proceeds to decision point 9. At decision point 9 it is determined whether this is the first VDT image for this number. If it is, the VDT record is deleted and at step 10, the image is marked processed image type 7, which means VDT was deleted, because LPR result did not meet minimum confidence level, and the process proceeds to step 14, explained below. If, at decision point 9, it is determined that this is not the first VDT for this number, then process proceeds to step 13, where the image is marked processed image type 9 which means this is the second image for this VDT and had an confidence level less than 100. After either steps 10 or 13, the process proceeds to step 14, where the image reviewer manually reviews the image and assigns a plate number to the image for use in toll processing. At decision point 15, the reviewer marks the image if it is a cross-lane image or a multi-plate image. In either case, the plate number is sent to Video Toll Processing Logic at step 20 In the case where, at decision point 4, the LPR confidence level is greater than 100, the process proceeds to decision point 5. At decision point 5, it is determined whether the LPM results match an existing VDT record. If the results match an existing record, then the process proceeds to decision point 6, where is it determined whether the existing VDT was verified by image review. If the VDT was verified by image review, then the process proceeds to decision point 7, where it is determined whether the LPM confidence level is greater than or equal to 950. If the LPM confidence level is greater than or equal to 950, the process proceeds to step 8, where the plate information from the matching VDT is added to a database. If the LPM confidence level is less than 950 then the process proceeds to step 12, where the image is marked processes as type 9, which means that the LPM result did not meet the minimum confidence level and the process proceeds to step 14 as described above.

If at decision point 6 it is determined that the VDT was not verified by image review, then the process proceeds to step 11. At step 11, the image is marked processed as image type 4, which means that the image matched a reviewed VDT but did not get imported to the library. The process then proceeds to step 14 and continues from there as described above.

If at decision point 5, it is determined that the LPM results do not match an existing VDT then the process proceeds to step 16. At step 16, the image reviewer reviews the image. Then, at step 17, it is determined whether the image is a cross lane or multi-plate image and, if so, the image is marked accordingly. If the image was a cross lane or multi-plate image, the VDT is deleted and the image is marked processed image type 10, which means the image was reviewed and was a cross lane or multi-plate image. If the image is not a cross lane or multi-plate image, then, at step 19, the image is verified and is sent to V-Toll processing logic at step 20.

Upon initial deployment of the system all images will go to an image reviewer (step 14) because there will not be any existing VTDs for the images. Steps 14, 15, 16, 17, 18 and 19 constitute an exemplary Image Review Process.

Steps 4, 5, 6, 7, 8, 9, 10, 11, 12 and 13 constitute an exemplary VDT matching process.

As will be recognized by one of skill in the art, the confidence levels described herein are exemplary and can be set to any level based on experience and performance of the process with increasing amounts of data.

In a further embodiment the following process is performed

A. All images captured at the lane are sent to the OCR/LPR/LPM server for processing.

B. Each image is assigned results for both the OCR/LPR (in the form of a license plate type and number) and for the LPM (in the form of a digital signature), and both results are accompanied with an associated confidence level.

C. Upon the initial deployment of this plan, these images will go straight to the image review team for manual review, as there will be no VDTs in the library to match against.

D. The image review clerk will be presented with the image only on the image review screen. The OCR/LPR results will not be pre-populated for the clerk.

E. The clerk will make his/her determination of the license plate origin, color, and number.

F. If the clerk enters data that matches the OCR/LPR result, the image is then placed into queue for VTOLL processing, and no further manual review is needed.

G. If the clerk enters data that does not match the OCR/LPR result, the image is pushed back into the queue for another image review clerk to identify.

H. If the second image review clerk enters data that matches the OCR/LPR result or the result of the first image review clerk, the image is placed into queue for vtoll processing with the matched information, and no further manual review is needed.

I. If the results of all three reviews (OCR/LPR, first image review, and second image review) differ, the image will be placed into the supervisor queue for final determination.

J. The supervisor will see the results from all three sources, enter his/her determination, and the results from the supervisor will accompany the image into queue for VTOLL processing.

K. After the initial image review process, the LPM results are now saved with the verified (or modified) OCR/LPR results in the VDT library.

L. Each subsequent image capture event where the OCR/LPR results (with a confidence level of at least 100) and LPM results with a confidence level of at least 700) match the stored data in the VDT library will automatically be sent to the VTOLL processing queue. This will greatly reduce the amount of images made available for manual review.

The process attempts to ensure that the license plate origin, code, color and number are accurate and correct for the current image and any future automated matches. The different matching scenarios are provided for in table 1. Accurate information for the vehicle under review is indicated by “C” for correct and inaccurate information is indicated by “I” for incorrect designation. Whenever the system value matches the reviewer value, the image is placed into the queue for VToll processing. Note that, while the intent of the process is to limit errors, they do occur in scenarios 3 and 6.

TABLE 1

| | | | | | | Do | |
|---|---|---|---|---|---|---|---|
| | System | Reviewer | System | Reviewer | System | A & B | |
| Scenario | Value | A | Value | B | Value | match? | Action |
| 1 | C | C | = | | | | accept reviewer A |
| 2 | C | I | NE | C | = | No | accept reviewer B |
| 3 | I | I | NE | I | NE | Yes | accept A or B |
| 4 | C | I | NE | I | NE | No | move to final |
| | | | | | | | review queue |
| 5 | I | C | NE | C | NE | Yes | accept A or B |
| 6 | I | C | NE | I | = | No | accept reviewer B |
| 7 | I | I | NE | C | NE | No | move to final |
| | | | | | | | review queue |

Following implementation of this process, the following images will still need manual review.

1. Images that have an OCR/LPR confidence result of less than 100 (scale of 0-1000).

2. Images that have an OCR/.LPR confidence result of 100 or greater, but do not have an existing VDT in the library.

3. Images that have a LPM confidence result of less than 700 (or some other threshold, e.g. 950).

4. Images that are identified as having two or more plates in the image during the OCR/LPR/LPM processing.

5. Images for which the OCR/LPR/LPM process is not able to identify a plate.

6. Images that are linked to a straddle transaction, whereby two images are captured of a vehicle driving on top of the lane striping, thereby “straddling” two lanes.

For Scenario 6, above, the Image Review screen can present the reviewer both images of the straddle transaction (i.e. one from each lane camera) to avoid incorrectly identifying any other vehicle that might be in the image.

As will be apparent to those skilled in the art in light of the foregoing disclosure, many alterations and modifications are possible in the practice of this invention without departing from the spirit or scope thereof. The foregoing description of preferred embodiments is by way of example, and is not intended to limit the scope of the invention in any way.

We claim:

1. A method for reading license plate characters, comprising:
capturing a license plate image
processing the image with optical character recognition equipment to produce an OCR result;
associating said OCR result with a confidence level;
presenting said image for a first manual review to produce a manual result without displaying to the reviewer said OCR result;
if said manual result matches said OCR result, determining that said OCR result is correct;
if said manual result does not match said OCR result, presenting said image for a second manual review by a different reviewer than said first manual reviewer to produce a second manual result;
if said second manual result matches said OCR result, determining that said OCR result is correct;
if said second manual result does not match said OCR result, presenting said image for a third manual review by a different reviewer than said first and second manual reviews;
if said third manual result matches said OCR result, determining that said OCR result is correct;
if said third manual result does not match said OCR result, presenting said image for a supervisory review by a different reviewer than said first, second and third manual reviews.

2. A method for reading license plate characters, comprising:
capturing a first license plate image;
processing said first image with optical character recognition equipment to produce an OCR result;
associating said OCR result with a confidence level;
if said confidence level is above a predetermined threshold, determining whether said OCR result matches a previously-obtained OCR result and
if said confidence level is not above said predetermined threshold, presenting said image for a manual review to produce a manual result.

3. The method of claim 2, further comprising, in the case where said confidence level is not above said predetermined threshold, providing at least one additional image for manual review of said image.

4. The method of claim 3, further comprising determining whether said first image contains multiple license plates.

5. The method of claim 3, further comprising determining whether said first image shows a vehicle straddling more than one traffic lane.

6. The method of claim 2, further comprising, in the case where said confidence level is above said predetermined threshold, determining whether said OCR result for a previously analyzed image was verified by manual image review.

7. The method of claim 6, further comprising, in the case where said confidence level is above said predetermined threshold and where said OCR result for a previously-analyzed image was verified by manual image review, determining whether said confidence level is above a second predetermined level, and if so, associating said OCR result with a video toll transaction.

8. The method of claim 6, further comprising, in the case where said confidence level is above said predetermined threshold but where said OCR result for a previously-analyzed image was not verified by manual image review, associating said first image with a first identifying flag and presenting said first image for manual review.

9. The method of claim 6, further comprising, in the case where said confidence level is above said predetermined threshold and where said OCR result for a previously-analyzed image was verified by manual image review, determining whether said confidence level is above a second predetermined level, and if not, associating said first image with a second identifying flag and presenting said first image for manual review.
